(19) United States
(12) Patent Application Publication
(10) Pub. No.: US 2003/0074274 A1
(43) Pub. Date: Apr. 17, 2003

(54) Mask trading system and method

(76) Inventors: Suigen Kyoh, Kawasaki-shi (JP); Osamu Ikenaga, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/247,522

(22) Filed: Sep. 20, 2002

(30) Foreign Application Priority Data
Sep. 21, 2001 (JP) 2001-290120

(51) Int. Cl. G06F 17/60

(52) U.S. Cl. 705/26; 700/117

(57) ABSTRACT

A mask trading system for trading a photo mask includes a purchase mediating section configured to exchange information with a mask buyer through a network. The system further includes a line information storing section and a calculating section. The line information storing section is configured to store line information, which includes information concerning processing lines for performing a plurality of processing modes. When the mask is manufactured by the processing modes in a mask factory, although substantially the same result is obtained in function of the mask, good/no-good evaluations in delivery date and price of the mask are reverse to each other in a case. The calculating section is configured to calculate an estimated delivery date and an estimated price of an ordered mask, in each of the cases of using the plurality of processing modes.

### CROSS-REFERENCE TO RELATED APPLICATIONS

This application is based upon and claims the benefit of priority from the prior Japanese Patent Application No. 2001-290120, filed Sep. 21, 2001, the entire contents of which are incorporated herein by reference.

### BACKGROUND OF THE INVENTION

1. Field of the Invention

The present invention relates to a mask trading system and method for trading, through a network, a photo mask used for manufacturing semiconductor devices.

2. Description of the Related Art

In general, trading of a photo mask used for manufacturing semiconductor devices proceeds basically as follows: First, a mask buyer gives a written order to a mask manufacturer. The written order contains various information, such as design specifications, quantity, desired delivery date, and examination specifications of the mask. The mask manufacturer manufactures the ordered mask in a factory in accordance with the written order. Then, the mask manufacturer examines the manufactured mask product. If the examination data of the product does not conform to the specifications in the written order, the mask manufacturer re-manufactures the ordered mask. In such a manner, the mask manufacturer repeats the manufacture and examination of the ordered mask until a manufactured mask product conforms to the specifications in the written order. Then, the final mask product is delivered to the buyer.

In recent years, the increase in the degree of integration and fineness of semiconductor circuits has brought about an increase in the degree of integration and fineness of photo masks used for light-exposure. Since a mask is used as a master plate for exposing wafers to light to transfer a pattern (device pattern) of a semiconductor device, the device pattern is printed on the mask. At present, there are two modes of drawing a device pattern on a mask. One of them is a method of sequentially drawing a device pattern, using a micron-meter sized probe, such as a laser or electron beam (which will be referred to as a sequential drawing mode, hereinafter). The other is a method of patterning each of regions of several centimeters of a mask at a time, using a master plate of a pattern to be formed on the mask, which is prepared in advance, (which will be referred to as a lump drawing mode, hereinafter).

The two drawing modes described above are quite different from each other in drawing principle, and thus they have completely different characteristics in terms of drawing preparation method and drawing time.

Accordingly, where these two drawing modes are respectively used for manufacturing a mask, a large difference is caused therebetween in delivery date or price of the mask, although substantially the same result is obtained in function of the mask. Among processing modes for manufacturing a mask, other than the drawing modes, there is a combination in which, although substantially the same result is obtained in function of the mask, good/no-good evaluations in delivery date and price of the mask are reverse to each other in a case; or fast/slow evaluations in necessary manufacturing time, and/or high/low evaluations in necessary manufacturing cost are reverse to each other, depending on the number of mask products to be manufactured. However, according to conventional mask trading methods, it is difficult in practice to exchange such detailed information between a mask buyer and a mask seller, in consideration of labor and time.

### BRIEF SUMMARY OF THE INVENTION

According to a first aspect of the present invention, there is provided a mask trading system for trading a photo mask used for manufacturing semiconductor devices, the system comprising:

a purchase mediating section configured to exchange information with a mask buyer through a network;

a manufacture order storing section configured to store a mask manufacture order, which includes design specifications and quantity of a mask, and is inputted through the purchase mediating section;

a delivery date information storing section configured to store delivery date information, which includes relationship between mask manufacturing method and mask delivery date;

a price information storing section configured to store price information, which includes relationship between mask manufacturing method and mask price;

a line information storing section configured to store line information, which includes information concerning processing lines for performing a plurality of processing modes, wherein, when a mask is manufactured by the processing modes in a mask factory, although substantially the same result is obtained in function of the mask, good/no-good evaluations in delivery date and price of the mask are reverse to each other in a case;

a calculating section configured to calculate an estimated delivery date and an estimated price of an ordered mask, in each of the cases of using the plurality of processing modes, with reference to the delivery date information, the price information, and the line information, in response to the mask manufacture order; and

a processing mode selection section configured to transmit the estimated delivery date and the estimated price of the ordered mask to the mask buyer through the purchase mediating section, and allow the mask buyer to select which one of the plurality of processing modes is used.

According to a second aspect of the present invention, there is provided a mask trading system for trading a photo mask used for manufacturing semiconductor devices, the system comprising:

a purchase mediating section configured to exchange information with a mask buyer through a network;

a manufacture order storing section configured to store a mask manufacture order, which includes design specifications and quantity of a mask, and is inputted through the purchase mediating section;

a delivery date information storing section configured to store delivery date information, which includes relationship between mask manufacturing method and mask delivery date;

a line information storing section configured to store line information, which includes information concerning processing lines for performing a plurality of processing modes, wherein, when a mask is manufactured by the processing modes in a mask factory, although substantially the same result is obtained in function of the mask, fast/slow evaluations in necessary manufacturing time are reverse to each other, depending on the number of mask products to be manufactured;

a calculating section configured to calculate an estimated delivery date for every mask product ordered, in each of the cases of using the plurality of processing modes, with reference to the delivery date information and the line information, in response to the mask manufacture order; and

a processing mode selection section configured to transmit the estimated delivery date for every mask product to the mask buyer through the purchase mediating section, and allow the mask buyer to select which one of the plurality of processing modes is used.

According to a third aspect of the present invention, there is provided a mask trading system for trading a photo mask used for manufacturing semiconductor devices, the system comprising:

a purchase mediating section configured to exchange information with a mask buyer through a network;

a manufacture order storing section configured to store a mask manufacture order, which includes design specifications and quantity of a mask, and is inputted through the purchase mediating section;

a price information storing section configured to store price information, which includes relationship between mask manufacturing method and mask price;

a line information storing section configured to store line information, which includes information concerning processing lines for performing a plurality of processing modes, wherein, when a mask is manufactured by the processing modes in a mask factory, although substantially the same result is obtained in function of the mask, high/low evaluations in necessary manufacturing cost are reverse to each other, depending on the number of mask products to be manufactured;

a calculating section configured to calculate an estimated price for every mask product ordered, in each of the cases of using the plurality of processing modes, with reference to the price information and the line information, in response to the mask manufacture order; and

a processing mode selection section configured to transmit the estimated price for every mask product to the mask buyer through the purchase mediating section, and allow the mask buyer to select which one of the plurality of processing modes is used.

### BRIEF DESCRIPTION OF THE SEVERAL VIEWS OF THE DRAWING

FIG. 1 is a block diagram showing how terminal units on a mask buyer side and a mask factory are related to a system for trading a photo mask used for manufacturing semiconductor devices, according to an embodiment of the present invention;

FIG. 2 is a flowchart showing the flow of a mask trading method performed by the system shown in FIG. 1;

FIG. 3 is a view showing a screen picture displayed for a mask buyer to input a mask manufacture order;

FIG. 4 is a view showing a screen picture displayed for the mask buyer to select whether to proceed with manufacture of the mask or not, and to select a drawing mode;

FIG. 5 is a view showing a screen picture displayed for the mask buyer when “Sequential drawing mode” or “Lump drawing mode” is selected in the screen picture shown in FIG. 4;

FIG. 6 is a view showing a screen picture displayed for the mask buyer when “File name” is inputted and “OK” is selected in the screen picture shown in FIG. 5;

FIG. 7 is a block diagram showing how terminal units on a mask buyer side and mask factories are related to a system for trading a photo mask used for manufacturing semiconductor devices, according to another embodiment of the present invention; and

FIG. 8 is a view showing a screen picture displayed for the mask buyer to select whether to proceed with manufacture of the mask or not, and to select a drawing mode, in the embodiment shown in FIG. 7.

### DETAILED DESCRIPTION OF THE INVENTION

In the process of developing the present invention, the inventors studied the sequential drawing mode and the lump drawing mode described above, which are representative processing modes having a large difference therebetween in estimated price or estimated delivery date of a mask. As a result, the present inventors have arrived at the findings given below.

In the sequential drawing mode, it is necessary only to convert the format from semiconductor device design data to drawing data, in preparation for mask-drawing. Accordingly, mask-drawing can be started in a short time after the completion of designing the semiconductor device. However, the mask pattern drawing takes much time, due to sequentially drawing a fine pattern. Accordingly, the drawing throughput is low, and the drawing apparatus cost per mask is high.

On the other hand, in the lump drawing mode, it is necessary to manufacture a master plate for mask products on the basis of semiconductor device design data, in preparation for mask-drawing. Accordingly, the lump drawing mode requires a longer time to prepare for the drawing, as compared with the sequential drawing mode, and also involves the cost of manufacturing a master plate. However, the mask pattern drawing takes very little time, because each of large regions is subjected to light-exposure at a time. Accordingly, the drawing throughput is high, and the drawing apparatus cost per mask is low.

The following table shows characteristics of the drawing modes. In the table, SDM and LDM stand for the sequential drawing mode and the lump drawing mode, respectively. A word enclosed by “and ” denotes a disadvantageous feature.

| | SDM | LDM |
|---|---|---|
| Master plate manufacture | No-needed | “Needed” |
| Drawing time | “Long” | Short |
| Apparatus cost per mask | “High” | Low |

From the viewpoint of mask delivery date, two items of Master plate manufacture and Drawing time in the table are important factors. In this respect, each of the sequential drawing mode and the lump drawing mode has one advantageous point and one disadvantageous point. From the viewpoint of mask cost, two items of Drawing time and Apparatus cost in the table important factors. In this respect, each of the drawing modes also has one advantageous point and one disadvantageous point. It is, therefore, difficult to simply determine which drawing mode should be used for mask-drawing, in light of delivery date and cost.

Furthermore, the mask delivery date is influenced by conditions, such as the number of other mask manufacture orders treated in a mask factory, and congestion level in each processing step in the mask factory. As regards the mask price, the lump drawing mode allows the master plate cost to spread over an ordered number of products of the same mask, thereby relatively lowering the master plate cost. As described above, in determining which drawing mode is preferable, not only functions of the drawing modes themselves, but also other factors may be complicatedly intertwined with each other.

Embodiments of the present invention achieved on the basis of the findings given above will now be described with reference to the accompanying drawings. In the following description, the constituent elements having substantially the same function and arrangement are denoted by the same reference numerals, and a repetitive description will be made only when necessary.

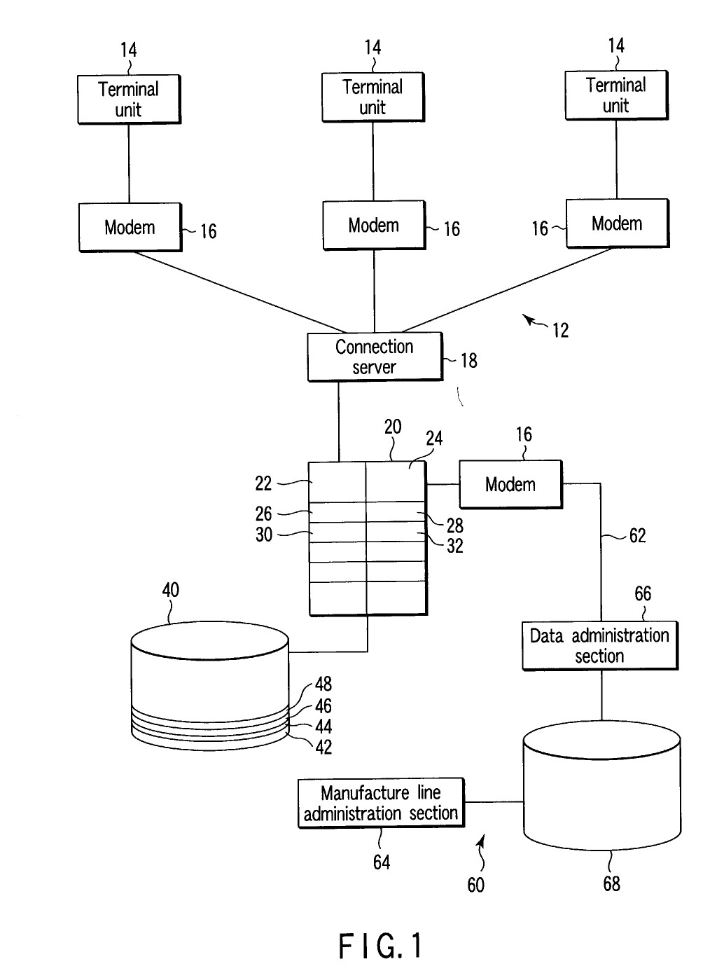

FIG. 1 is a block diagram showing how terminal units on a mask buyer side and a mask factory are related to a system for trading a photo mask used for manufacturing semiconductor devices, according to an embodiment of the present invention.

In this embodiment, a host apparatus (imaginary factory) 20 of the mask trading system is disposed at a site accessible by a user's terminal unit 14, such as a personal computer, through a network 12, particularly through the transmission lines of Internet (public communication network). Accordingly, the host apparatus 20, i.e., a host computer (including a web server, application server, and database server), has a purchase agent (a purchase mediating section) 22, which is connected to the network 12 and is used as a window to exchange information with a mask buyer (a client or user, or a salesman on behalf of the client). The host apparatus 20 also has a sales agent (a sales mediating section) 24, which is connected through an exclusive line 62 to the mask factory 60 (a mask manufacturer and seller) and is used as a window to exchange information with the mask factory 60. Reference symbols 16 and 18 in FIG. 1 denote a modem and a connection server, respectively.

The host apparatus 20 is provided with a database 40, in which a manufacture order file 42, a delivery date information file 44, a price information file 46, a line information file 48, and so forth are formed. The manufacture order file 42 is used to store a mask manufacture order, which includes the product name, quantity, design specifications, and so forth of an ordered mask, and is inputted through the purchase agent 22. Where product names or product numbers of masks are set in advance between a mask buyer and the mask seller, the product names or product numbers of masks can be used as information representing design specifications of masks. The delivery date information file 44 is used to store delivery date information, which includes the relationship between mask manufacturing method and mask delivery date. The price information file 46 is used to store price information, which includes the relationship between mask manufacturing method and mask price.

The line information file 48 is used to store line information, which relates to manufacture lines in the mask factory 60, and is inputted through the sales agent 24 whenever necessary (for example, immediately after receiving each mask manufacture order). The line information includes the conditions, congestion levels, and shutdown schedules of processing lines (apparatuses) for performing a sequential drawing mode and a lump drawing mode, and the conditions, congestion levels, shutdown schedules, and yields of other processing apparatuses and examination apparatuses. The line information also includes drawing histories of masks processed in the past by the drawing processing apparatuses in the mask factory 60. The sequential drawing mode and the lump drawing mode are examples of the processing modes, in which, although substantially the same result is obtained in function of the mask, good/no-good evaluations in delivery date and price of the mask are reverse to each other in a case; or fast/slow evaluations in necessary manufacturing time, and/or high/low evaluations in necessary manufacturing cost are reverse to each other, depending on the number of mask products to be manufactured.

In order to perform mediation between a mask buyer and the mask seller, utilizing the above-described information stored in the database 40, the host apparatus 20 has an order receiving section 26, a calculating section 28, a processing mode selection section 30, a manufacture instruction section 32, and so forth. The order receiving section 26 receives a mask manufacture order inputted by a mask buyer through the purchase agent 22, as described above. The calculating section 28 calculates an estimated delivery date and an estimated price for every mask product ordered, and accuracy of the estimated delivery date for every mask product, in either of the cases of using the sequential drawing mode and the lump drawing mode, with reference to the delivery date information, the price information, and the line information described above, in response to the mask manufacture order. The processing mode selection section 30 transmits information representing the estimated delivery date, the estimated price, and the accuracy of the estimated delivery date to the mask buyer through the purchase agent 22, who utilizes the information to select which one of the sequential drawing mode and the lump drawing mode should be used. The manufacture instruction section 32 transmits the mask manufacture order to the mask factory 60 through the sales agent 24, when one of the processing modes is selected in the processing mode selection section 30, and proceeding with manufacture of the mask is selected in the order receiving section 26.

In the mask factory 60, the mask manufacture lines are administered by a manufacture line administration section 64 formed of, e.g., a computer. The mask factory 60 is connected to the host apparatus 20 of the mask trading system only by a data administration section 66 formed of, e.g., a computer. The manufacture line administration section 64 and the data administration section 66 are connected to a common factory database 68. The factory database 68 is used to store information transferred to and from the host apparatus 20 of the mask trading system, i.e., mask manufacture orders from mask buyers, line information including information concerning the processing lines (apparatuses) for performing the sequential drawing mode and the lump drawing mode, and so forth.

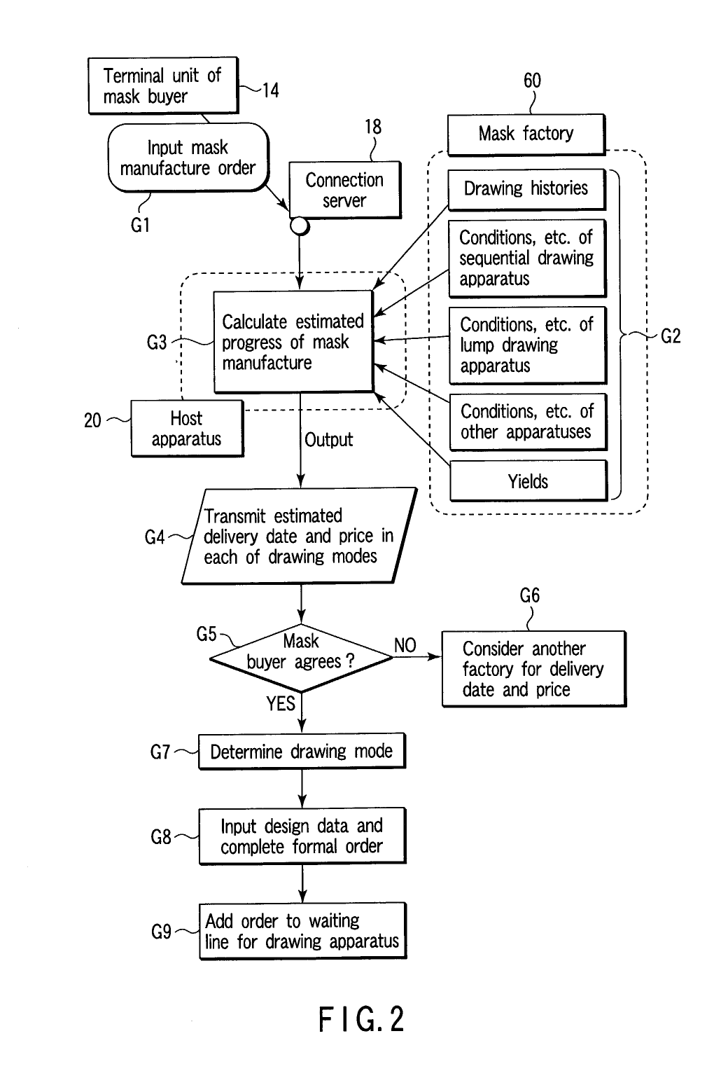

FIG. 2 is a flowchart showing the flow of a mask trading method performed by the system shown in FIG. 1. An explanation will be given of a mask trading method according to an embodiment of the present invention, with reference to FIG. 2.

First, a mask buyer connects a user terminal unit 14 to the host apparatus 20 of the mask trading system through the network 12. It may be adopted to require an ID and a password, when a user terminal unit 14 is connected to the host apparatus 20. In this case, only users with a specific contract are allowed to access the host apparatus 20. Then, the mask buyer inputs a mask manufacture order including the product name, quantity, design specifications, and so forth of the ordered mask, through the purchase agent 22 into the order receiving section 26 (step G1). The order receiving section 26 stores the inputted mask manufacture order in the manufacture order file 42 in the database 40.

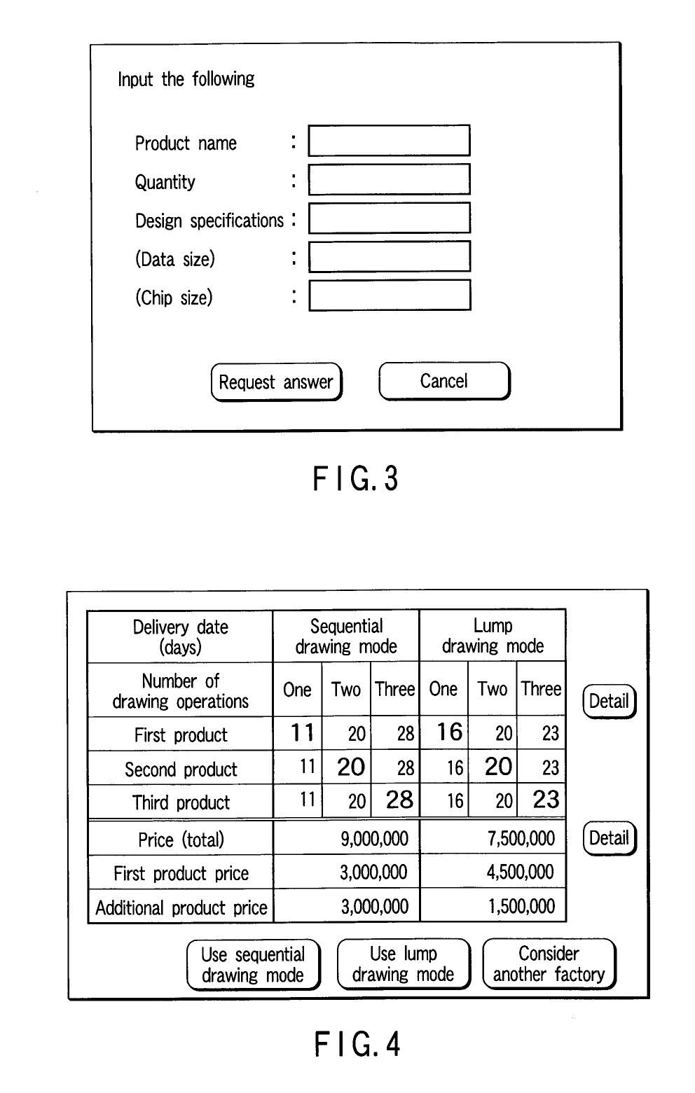

FIG. 3 is a view showing a screen picture displayed for the mask buyer to input the mask manufacture order. In FIG. 3, “Product name” can be used where product names or product numbers of masks are set in advance between the mask buyer and the mask factory 60. In other words, a product name or product number of a mask is used as information representing design specifications of the mask, as the case may be. “Data size” and “Chip size” are part of design specifications of the mask. When “Request answer” is selected in the screen picture shown in FIG. 3, the information described above is transmitted to the host apparatus 20 through the connection server 18.

When the mask manufacture order is inputted, the order receiving section 26 decides whether the ordered mask can be manufactured or not. Where the mask cannot be manufactured, the mask buyer is informed of this fact, and the trade does not take place. No explanation will be given of this case, because this departs from the features of the embodiment. Where the mask can be manufactured, the order receiving section 26 inquires of the mask factory 60 the latest line information on the mask manufacture lines.

In response to this inquiry from the order receiving section 26, the mask factory 60 inputs the latest line information through the sales agent 24 (step G2). The host apparatus 20 renews the line information in the line information file 44 with the latest line information. The line information includes the conditions, congestion levels, and shutdown schedules of the processing lines (apparatuses) for performing the sequential drawing mode and the lump drawing mode, and the conditions, congestion levels, shutdown schedules, and yields of other processing apparatuses and examination apparatuses. The line information also includes drawing histories as to whether a mask corresponding to the mask manufacture order was processed in the past by the drawing processing apparatuses in the mask factory 60. At this time, the delivery date information file 44 and the price information file 46 have already stored the delivery date information and the price information, which include the relationship of mask delivery date and mask price relative to mask manufacturing method, respectively.

Then, the calculating section 28 calculates an estimated delivery date and an estimated price for every mask product ordered, and accuracy of the estimated delivery date for every mask product, in either of the cases of using the sequential drawing mode and the lump drawing mode, with reference to the delivery date information, the price information, and the latest line information described above (step G3). An explanation will be given of a manner of calculating an estimated delivery date and accuracy thereof for every mask product ordered, in either of the cases of using the sequential drawing mode and the lump drawing mode.

Where the sequential drawing mode is used, the time necessary for mask manufacture is the sum of wait time T1 for drawing (120 h), average stay time T2 of an NG mask in the steps (80 h), average wait time T3 for re-drawing of an NG mask (100 h), and average time T4 of the steps other than drawing (150 h). A delivery date is estimated on the bases of these parameters, but the chance of forming a good product by one drawing is low in the present mask manufacture, because of a low yield brought about by the increase in the degree of fineness, as described in the Description of the Related Art. Where an NG occurs during the manufacture steps, it is necessary to restart from drawing, thereby causing a large difference in delivery date. Accordingly, in order to accurately estimate delivery date, estimation of delivery date for every drawing operation is preferable.

Where a good product is obtained by the first drawing, the delivery date is in (T1+T4)=270 h=11 days. Where an NG occurs during one of the steps, it is in (T1+T2+T3+T4)=470 h=20 days. Where an NG occurs again to the second product, a third drawing has to be performed, and thus the delivery date is in (T1+T2+T3+T2+T3+T4)=670 h=28 days.

Where the lump drawing mode is used, the delivery date and the price vary, depending on whether a manufacture-ordered mask is the first print and thus requires a new master plate to be fabricated, or is a reprint from an existing master plate. Where a mask is a first print and thus requires a new master plate to be fabricated, the time necessary for mask manufacture is the sum of the master plate preparing time T11 (240 h), average stay time T2 of an NG mask in the steps (80 h), average wait time T13 for re-drawing of an NG mask (5 h), and average time T4 of the steps other than drawing (150 h). A delivery date or time for every drawing operation is calculated, as described above. Where a good product is obtained by the first drawing, the delivery date is in (T11+T4)390 h=16 days. For the second drawing, it is in (T11+T2+T13+T4)=475 h=20 days. For the third drawing, it is in (T11+T2+T13+T2+T13+T4)=560 h=23 days.

Following the calculation of the estimated delivery date, the calculating section 28 calculates accuracy of the estimated delivery date. At this time, the calculating section 28 refers to product yield of the mask included in the line information in the line information file 44. For example, where the sequential drawing mode has a yield of 35%, and three mask products are ordered, the probability of completing the three products each by the first drawing is the third power of 35%, which is 4%. The probability of obtaining two good products out of three products each by the first drawing is 23%. The probability of obtaining one good product out of three products each by the first drawing is 44%. The probability of obtaining no good product out of three products each by the first drawing is 28%. In other words, the chance of being able to deliver one of the necessary three mask products after the first drawing is high, but those for the second and third of the three mask products are low. Such calculation is performed to obtain accuracy of the estimated delivery date for every mask product, and for every drawing operation, in either of the cases of using the sequential drawing mode and the lump drawing mode.

The processing mode selection section 30 transmits (displays) information, which represents the estimated delivery date, the estimated price, and the accuracy of the estimated delivery date thus calculated, to the mask buyer through the purchase agent 22 (step G4).

On the basis of the transmitted calculation results, the mask buyer selects whether to proceed with manufacture of the mask or not, and which one of the sequential drawing mode and the lump drawing mode should be used (step G5).

FIG. 4 is a view showing a screen picture displayed for the mask buyer to select whether to proceed with manufacture of the mask or not, and to select a drawing mode. As shown in FIG. 4, in this screen picture, estimated delivery dates (each by the necessary days in this example) are displayed for every mask product ordered, along with the number of drawing operations, in either of the cases of using the sequential drawing mode and the lump drawing mode. In the picture, a delivery date with the highest accuracy is indicated in bold numbers, as information representing accuracy of the estimated delivery date for every mask product. Furthermore, the price of the first product in accordance with the ordered mask, and the price of the second or thereafter product in accordance with the ordered mask (an additional product price) are shown as the estimated price for every mask product. In the case of the lump drawing mode, the price of the first product includes a cost for manufacturing a master plate. Accordingly, where the master plate is already existing, the price of ordered mask products starts from the additional product price from the first product. Where “Detail” is selected in the screen picture shown in FIG. 4, further details of the accuracy of the estimated delivery date, and a breakdown of the total price of the estimated price are displayed.

Where the mask buyer is not satisfied with the transmitted calculation results, and “Consider another factory” is selected in the screen picture shown in FIG. 4 (step G6), the mask trading does not take place. In this case, it may be preset that the host apparatus 20 automatically switches the connection from the mask factory 60 to another mask manufacturer and seller, or another mask factory. When “Sequential drawing mode” or “Lump drawing mode” is selected in the screen picture shown in FIG. 4, the screen picture shown in FIG. 5 is displayed (step G7).

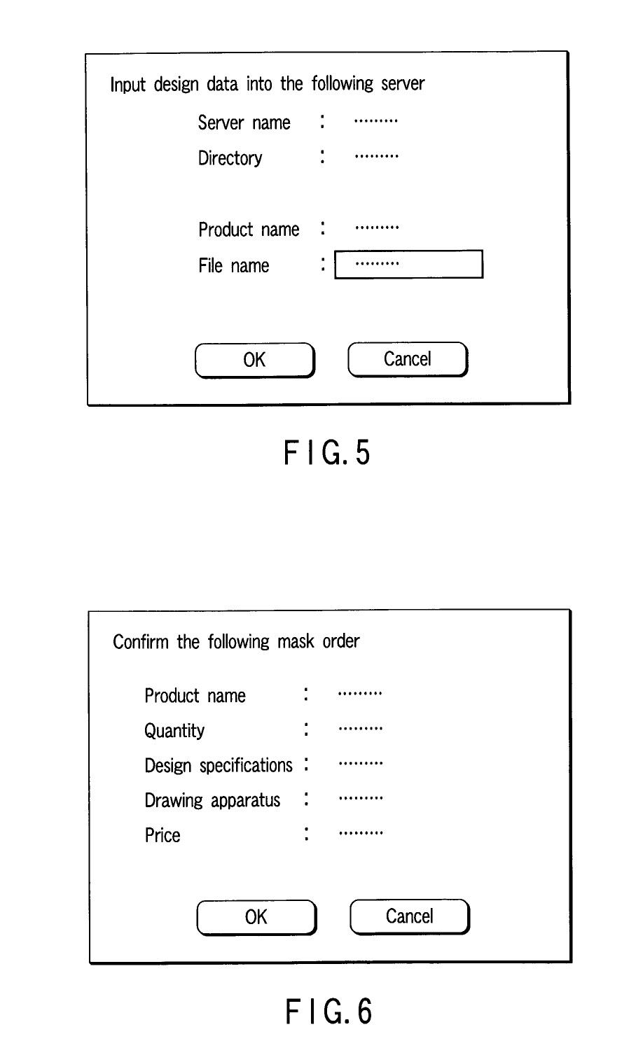

As shown in FIG. 5, in this screen picture, an addressee for design data corresponding to the mask manufacture order is shown to the mask buyer. Where “File name” is inputted and “OK” is selected by the mask buyer in the screen picture shown in FIG. 5 (step G8), the screen picture shown in FIG. 6 is displayed. The screen picture shown in FIG. 6 is an order confirmation screen picture, in which, when “OK” is further selected in the picture (step G8), a formal order is completed. When “Cancel” is selected in the screen picture shown in FIGS. 5 or 6, the mask trading does not take place.

The host apparatus 20 stores the confirmed mask manufacture order along with the estimated delivery date and the estimated price in the manufacture order file 42. The manufacture instruction section 32 transmits the mask manufacture order to the data administration section 66 of the mask factory 60 through the sales agent 24. Upon receiving the mask manufacture order, the data administration section 66 adds this mask manufacture order to a waiting line for the drawing processing line of the selected mode (step G9).

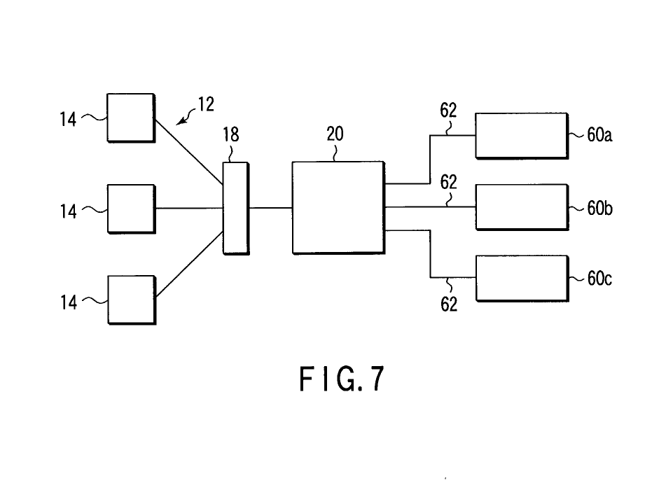

In the embodiment shown in FIG. 1, only one mask factory 60 is connected to the host apparatus 20 of the mask trading system, but a plurality of mask factories may be connected to the host apparatus 20 in parallel (see FIG. 7) or in series. Where only one mask factory 60 is connected to the host apparatus 20 of the mask trading system, the data administration section 66 of the mask factory 60 and the host apparatus 20 of the mask trading system may be unified.

FIG. 7 is a block diagram showing how terminal units on a mask buyer side and mask factories are related to a system for trading a photo mask used for manufacturing semiconductor devices, according to another embodiment of the present invention. In this embodiment, there is shown a host apparatus 20 connected to three mask factories 60a, 60b, and 60c. The relationship between the host apparatus 20 and each of the mask factories 60a, 60b, and 60c is the same as that of the system shown in FIG. 1.

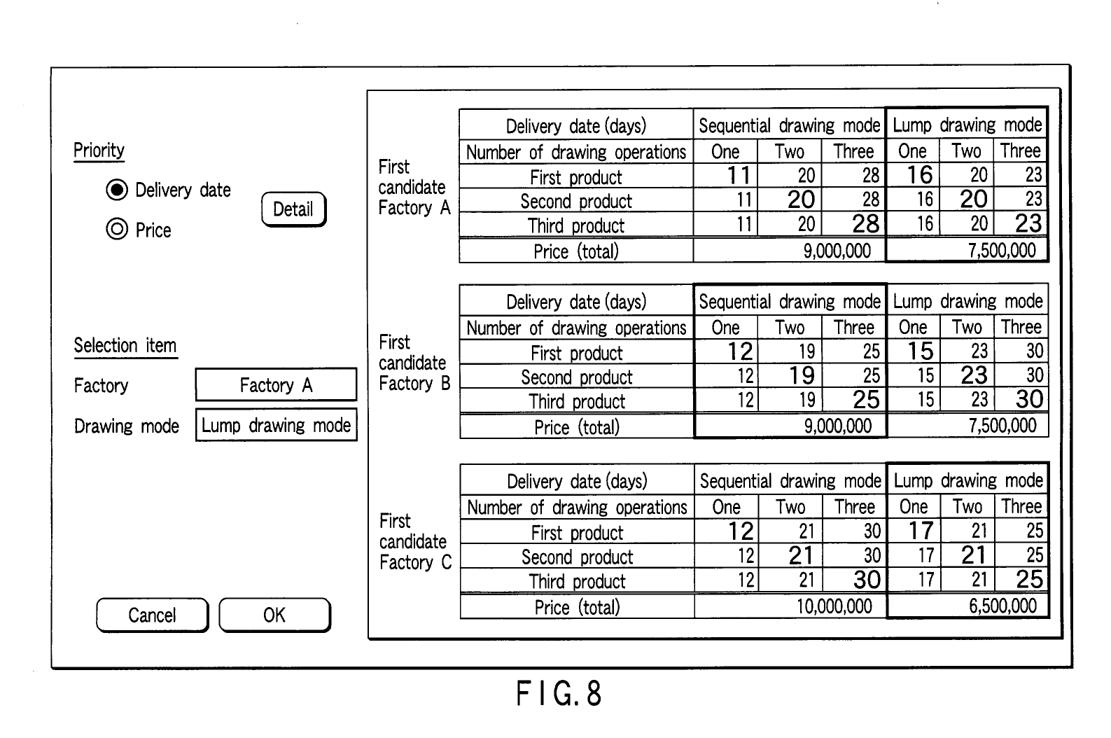

In the embodiment, when “Request answer” is selected in the screen picture shown in FIG. 3, the screen picture shown in FIG. 8 is displayed in place of the screen picture shown in FIG. 4. In the screen picture shown in FIG. 8, only total prices are displayed as estimated prices, but it is preset that, when “Detail” is selected in the screen picture shown in FIG. 8, details, such as a first product price and an additional product price as in the screen picture shown in FIG. 4, are displayed. In the screen picture shown in FIG. 8, the mask buyer is allowed to select which one of the delivery date and the price is given priority. FIG. 8 shows the case where “Delivery date” is selected as a priority matter. On the basis of the displayed information, the mask buyer can select a mask factory and a drawing mode, according to needs.

According to the embodiments described above, there is provided a mask trading system and method, which allow a mask buyer and a mask seller to exchange detailed information with each other, thereby enabling the mask buyer to place a mask manufacture order according to needs.

In the embodiments described above, the sequential drawing mode and the lump drawing mode are explained as examples of the processing modes, in which, although substantially the same result is obtained in function of the mask, good/no-good evaluations in delivery date and price of the mask are reverse to each other in a case; or fast/slow evaluations in necessary manufacturing time, and/or high/low evaluations in necessary manufacturing cost are reverse to each other, depending on the number of mask products to be manufactured. The present invention, however, may be applied to processing modes other than the drawing modes, which fit the conditions described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask trading system for trading a photo mask used for manufacturing semiconductor devices, the system comprising:
a purchase mediating section configured to exchange information with a mask buyer through a network;
a manufacture order storing section configured to store a mask manufacture order, which includes design specifications and quantity of a mask, and is inputted through the purchase mediating section;
a delivery date information storing section configured to store delivery date information, which includes relationship between mask manufacturing method and mask delivery date;
a price information storing section configured to store price information, which includes relationship between mask manufacturing method and mask price;
a line information storing section configured to store line information, which includes information concerning processing lines for performing a plurality of processing modes, wherein, when a mask is manufactured by the processing modes in a mask factory, although substantially the same result is obtained in function of the mask, good/no-good evaluations in delivery date and price of the mask are reverse to each other in a case;
a calculating section configured to calculate an estimated delivery date and an estimated price of an ordered mask, in each of the cases of using the plurality of processing modes, with reference to the delivery date information, the price information, and the line information, in response to the mask manufacture order; and
a processing mode selection section configured to transmit the estimated delivery date and the estimated price of the ordered mask to the mask buyer through the purchase mediating section, and allow the mask buyer to select which one of the plurality of processing modes is used.

2. A trading system according to claim 1, wherein the plurality of processing modes comprise processing modes, in which fast/slow evaluations in necessary manufacturing time are reverse to each other, depending on the number of mask products to be manufactured, and wherein the calculating section is configured to calculate an estimated delivery date for every mask product ordered, in each of the cases of using the plurality of processing modes, and the processing mode selection section is configured to transmit the estimated delivery date for every mask product to the mask buyer through the purchase mediating section.

3. A trading system according to claim 2, wherein the calculating section is configured to calculate accuracy of the estimated delivery date for every mask product, and the processing mode selection section is configured to transmit information representing accuracy of the estimated delivery date for every mask product to the mask buyer through the purchase mediating section.

4. A trading system according to claim 1, wherein the plurality of processing modes comprise processing modes, in which high/low evaluations in necessary manufacturing cost are reverse to each other, depending on the number of mask products to be manufactured, and wherein the calculating section is configured to calculate an estimated price for every mask product ordered, in each of the cases of using the plurality of processing modes, and the processing mode selection section is configured to transmit the estimated price for every mask product to the mask buyer through the purchase mediating section.

5. A trading system according to claim 1, further comprising a sales mediating section configured to exchange information with a mask seller, wherein the line information is renewed with information concerning the processing lines, which is inputted through the sales mediating section after the mask manufacture order is inputted.

6. A trading system according to claim 1, wherein the plurality of processing modes comprise a first processing mode of performing sequential drawing of a mask pattern, and a second processing mode of performing lump drawing of a mask pattern, using a master plate.

7. A mask trading system for trading a photo mask used for manufacturing semiconductor devices, the system comprising:
a purchase mediating section configured to exchange information with a mask buyer through a network;
a manufacture order storing section configured to store a mask manufacture order, which includes design specifications and quantity of a mask, and is inputted through the purchase mediating section;
a delivery date information storing section configured to store delivery date information, which includes relationship between mask manufacturing method and mask delivery date;
a line information storing section configured to store line information, which includes information concerning processing lines for performing a plurality of processing modes, wherein, when a mask is manufactured by the processing modes in a mask factory, although substantially the same result is obtained in function of the mask, fast/slow evaluations in necessary manufacturing time are reverse to each other, depending on the number of mask products to be manufactured;
a calculating section configured to calculate an estimated delivery date for every mask product ordered, in each of the cases of using the plurality of processing modes, with reference to the delivery date information and the line information, in response to the mask manufacture order; and
a processing mode selection section configured to transmit the estimated delivery date for every mask product to the mask buyer through the purchase mediating section, and allow the mask buyer to select which one of the plurality of processing modes is used.

8. A trading system according to claim 7, further comprising a sales mediating section configured to exchange information with a mask seller, wherein the line information is renewed with information concerning the processing lines, which is inputted through the sales mediating section after the mask manufacture order is inputted.

9. A trading system according to claim 7, wherein the plurality of processing modes comprise a first processing mode of performing sequential drawing of a mask pattern, and a second processing mode of performing lump drawing of a mask pattern, using a master plate.

10. A mask trading system for trading a photo mask used for manufacturing semiconductor devices, the system comprising:
a purchase mediating section configured to exchange information with a mask buyer through a network;
a manufacture order storing section configured to store a mask manufacture order, which includes design specifications and quantity of a mask, and is inputted through the purchase mediating section;
a price information storing section configured to store price information, which includes relationship between mask manufacturing method and mask price;
a line information storing section configured to store line information, which includes information concerning processing lines for performing a plurality of processing modes, wherein, when a mask is manufactured by the processing modes in a mask factory, although substantially the same result is obtained in function of the mask, high/low evaluations in necessary manufacturing cost are reverse to each other, depending on the number of mask products to be manufactured;
a calculating section configured to calculate an estimated price for every mask product ordered, in each of the cases of using the plurality of processing modes, with reference to the price information and the line information, in response to the mask manufacture order; and
a processing mode selection section configured to transmit the estimated price for every mask product to the mask buyer through the purchase mediating section, and allow the mask buyer to select which one of the plurality of processing modes is used.

11. A trading system according to claim 10, further comprising a sales mediating section configured to exchange information with a mask seller, wherein the line information is renewed with information concerning the processing lines, which is inputted through the sales mediating section after the mask manufacture order is inputted.

12. A trading system according to claim 10, wherein the plurality of processing modes comprise a first processing mode of performing sequential drawing of a mask pattern, and a second processing mode of performing lump drawing of a mask pattern, using a master plate.

13. A mask trading method of trading a photo mask used for manufacturing semiconductor devices, using a system including a purchase mediating section configured to exchange information with a mask buyer through a network, the method comprising:
storing a mask manufacture order, which includes design specifications and quantity of a mask, and is inputted through the purchase mediating section;
storing delivery date information, which includes relationship between mask manufacturing method and mask delivery date;
storing price information, which includes relationship between mask manufacturing method and mask price;
storing line information, which includes information concerning processing lines for performing a plurality of processing modes, wherein, when a mask is manufactured by the processing modes in a mask factory, although substantially the same result is obtained in function of the mask, good/no-good evaluations in delivery date and price of the mask are reverse to each other in a case;
calculating an estimated delivery date and an estimated price of an ordered mask, in each of the cases of using the plurality of processing modes, with reference to the delivery date information, the price information, and the line information, in response to the mask manufacture order; and
transmitting the estimated delivery date and the estimated price of the ordered mask to the mask buyer through the purchase mediating section, and allowing the mask buyer to select which one of the plurality of processing modes is used.

14. A trading method according to claim 13, wherein the plurality of processing modes comprise processing modes, in which fast/slow evaluations in necessary manufacturing time are reverse to each other, depending on the number of mask products to be manufactured, and wherein the trading method further comprises calculating an estimated delivery date for every mask product ordered, in each of the cases of using the plurality of processing modes, and transmitting the estimated delivery date for every mask product to the mask buyer through the purchase mediating section.

15. A trading method according to claim 14, further comprising calculating accuracy of the estimated delivery date for every mask product, and transmitting information representing accuracy of the estimated delivery date for every mask product to the mask buyer through the purchase mediating section.

16. A trading method according to claim 13, wherein the plurality of processing modes comprise processing modes, in which high/low evaluations in necessary manufacturing cost are reverse to each other, depending on the number of mask products to be manufactured, and wherein the trading method further comprises calculating an estimated price for every mask product ordered, in each of the cases of using the plurality of processing modes, and transmitting the estimated price for every mask product to the mask buyer through the purchase mediating section.

17. A trading method according to claim 13, wherein the trading system further comprises a sales mediating section configured to exchange information with a mask seller, and the trading method further comprises renewing the line information with information concerning the processing lines, which is inputted through the sales mediating section after the mask manufacture order is inputted.

18. A trading method according to claim 13, wherein the plurality of processing modes comprise a first processing mode of performing sequential drawing of a mask pattern, and a second processing mode of performing lump drawing of a mask pattern, using a master plate.

19. A mask trading method of trading a photo mask used for manufacturing semiconductor devices, using a system including a purchase mediating section configured to exchange information with a mask buyer through a network, the method comprising:
storing a mask manufacture order, which includes design specifications and quantity of a mask, and is inputted through the purchase mediating section;
storing delivery date information, which includes relationship between mask manufacturing method and mask delivery date;
storing line information, which includes information concerning processing lines for performing a plurality of processing modes, wherein, when a mask is manufactured by the processing modes in a mask factory, although substantially the same result is obtained in function of the mask, fast/slow evaluations in necessary manufacturing time are reverse to each other, depending on the number of mask products to be manufactured;
calculating an estimated delivery date for every mask product ordered, in each of the cases of using the plurality of processing modes, with reference to the delivery date information and the line information, in response to the mask manufacture order; and
transmitting the estimated delivery date for every mask product to the mask buyer through the purchase mediating section, and allowing the mask buyer to select which one of the plurality of processing modes is used.

20. A trading method according to claim 19, wherein the trading system further comprises a sales mediating section configured to exchange information with a mask seller, and the trading method further comprises renewing the line information with information concerning the processing lines, which is inputted through the sales mediating section after the mask manufacture order is inputted.

21. A trading method according to claim 19, wherein the plurality of processing modes comprise a first processing mode of performing sequential drawing of a mask pattern, and a second processing mode of performing lump drawing of a mask pattern, using a master plate.

22. A mask trading method of trading a photo mask used for manufacturing semiconductor devices, using a system including a purchase mediating section configured to exchange information with a mask buyer through a network, the method comprising:
storing a mask manufacture order, which includes design specifications and quantity of a mask, and is inputted through the purchase mediating section;
storing price information, which includes relationship between mask manufacturing method and mask price;
storing line information, which includes information concerning processing lines for performing a plurality of processing modes, wherein, when a mask is manufactured by the processing modes in a mask factory, although substantially the same result is obtained in function of the mask, high/low evaluations in necessary manufacturing cost are reverse to each other, depending on the number of mask products to be manufactured;
calculating an estimated price for every mask product ordered, in each of the cases of using the plurality of processing modes, with reference to the price information and the line information, in response to the mask manufacture order; and
transmitting the estimated price for every mask product to the mask buyer through the purchase mediating section, and allowing the mask buyer to select which one of the plurality of processing modes is used.

23. A trading method according to claim 22, wherein the trading system further comprises a sales mediating section configured to exchange information with a mask seller, and the trading method further comprises renewing the line information with information concerning the processing lines, which is inputted through the sales mediating section after the mask manufacture order is inputted.

24. A trading method according to claim 22, wherein the plurality of processing modes comprise a first processing mode of performing sequential drawing of a mask pattern, and a second processing mode of performing lump drawing of a mask pattern, using a master plate.
